(19) United States
(12) Patent Application Publication
(10) Pub. No.: US 2022/0092487 A1
(43) Pub. Date: Mar. 24, 2022

(54) PAY-BY-HOUR FACILITY

(71) Applicant: TAISHO SKY BUILDING, INC., Tokyo (JP)

(72) Inventor: Kazuharu ISHIDA, Tokyo (JP)

(21) Appl. No.: 17/455,888

(22) Filed: Nov. 19, 2021

Related U.S. Application Data
(63) Continuation of application No. PCT/JP2019/019824, filed on May 20, 2019.

(51) Int. Cl. G06Q 10/02; G06Q 30/06

(52) U.S. Cl. CPC G06Q 10/02; G06Q 30/0645

(57) ABSTRACT

A management server of a reservation system is connected to a terminal device via a communication network and is configured to obtain user information of a user from the terminal device; set a reservation upper limit time for the user to make reservations during a predetermined period; receive a first reservation having a first usage time from the terminal device; determine whether the first usage time exceeds the reservation upper limit time; and in accordance with a determination that the first usage time does not exceed the reservation upper limit time: manage a reservation date and time as reservation information of the first reservation, and generate a first updated reservation upper limit time by subtracting the first usage time from the reservation upper limit time.

### RELATED APPLICATIONS

The present application is a continuation of International Patent Application No. PCT/JP2019/019824, filed May 20, 2019, which is hereby incorporated by reference in its entirety.

### TECHNICAL FIELD

This disclosure relates to an on-demand reservation system for setting a usage time and renting a facility to a user.

### BACKGROUND

A system for renting rooms of a building (e.g., an office, a hotel, or the like) to users typically includes a management server open to a communication network such as the Internet, and a plurality of reservation servers in which information on the conference room is stored. Such a system is typically configured so that users can access information describing the conference room in a reservation server via the management server and reserve a desired conference room. Such a system also typically has a billing function so that a rental fee can be paid online.

Electronic tickets (coupon tickets) for adjusting use of a rental space have been proposed. There are three ways to use such tickets. An electronic ticket may rent the space for a specified time, rent the space without specifying the time, or rent the space by the hour. The user can use an electronic ticket properly depending on whether the user wants to specify the time in advance or hold the electronic ticket as a coupon without specifying a time. The user can use the electronic ticket (coupon ticket) as a reservation ticket, or a space use ticket that can be used on a given day.

However, since conventional systems charge a usage fee each time the facility is used, the user has to be careful when making a reservation and sometimes hesitates to make the reservation, and it has thus been difficult to improve user convenience. Further, in conventional systems, reservations are typically concentrated on a specific day of the week or time of day, which could lead to decreases in operational efficiency of the reservation system.

### SUMMARY

An object of the present disclosure is to provide an on-demand reservation system (also referred to as a rental facility) that makes it easier to receive user reservations, improves user convenience, and improves operational efficiency.

The on-demand reservation system of the present disclosure is an on-demand reservation system for setting a usage time and renting a facility to a user, including a management device (also referred to as a host) that is connected to a user input unit for receiving input from the user via a communication line and manages the facility, in which the management device includes: a user information manager that manages user information on a predetermined user and a reservation upper limit time in which an upper limit time given to the user in advance and able to be reserved during a predetermined period is set; a reservation information manager that manages the usage time and reservation date and time as reservation information when a usage time within a range not exceeding the reservation upper limit time is received from the user input unit; and a reservation time updater that updates information of the reservation upper limit time by subtracting the usage time from the reservation upper limit time, when the reservation information manager receives a reservation, and updates the information of the reservation upper limit time by adding the usage time in the reservation information to the reservation upper limit time, when the reservation date and time of the reservation information has passed or when the reservation information has been deleted.

According to the present disclosure, the management device of the on-demand reservation system includes: the user information manager that manages the user information and the reservation upper limit time; the reservation information manager that manages the usage time and the reservation date and time as the reservation information; and the reservation time updater that updates the information of the reservation upper limit time by subtracting the usage time from the reservation upper limit time, and the reservation time updater updates the information of the reservation upper limit time by adding the usage time in the reservation information to the reservation upper limit time, when the reservation date and time of the reservation information has passed or when the reservation information has been deleted, so that the user can repeatedly use the facility during the predetermined period. Therefore, the user can easily make the reservation as long as the reservation upper limit time is not exceeded, and the on-demand reservation system can improve the convenience of the user. In addition, when the reservation date and time has passed or the reservation information has been deleted (cancelled), the usage time for the reservation is added to update the reservation upper limit time, so that the user is encouraged to actively make a reservation, and the operation efficiency of the facility can be improved.

In some implementations, the management device includes a billing manager that charges a rental fee according to a length of the reservation upper limit time during a predetermined period.

According to such a configuration, the management device includes the billing manager that charges the rental fee according to the length of the reservation upper limit time during the predetermined period, so that the user can repeatedly use the on-demand reservation system at a flat rate within the range not exceeding the reservation upper limit time

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a schematic configuration diagram of an on-demand reservation system in accordance with some implementations.

FIG. 2 is a block diagram illustrating a configuration of a management device of the on-demand reservation system in accordance with some implementations.

FIG. 3 is a flowchart illustrating an operation of the management device of the on-demand reservation system in accordance with some implementations.

FIG. 4 illustrates a reservation operation in the on-demand reservation system.

FIG. 5 illustrates another reservation operation in the on-demand reservation system.

FIG. 6 illustrates still another reservation operation in the on-demand reservation system.

### DETAILED DESCRIPTION

Hereinafter, implementations of the present disclosure will be described with reference to the drawings.

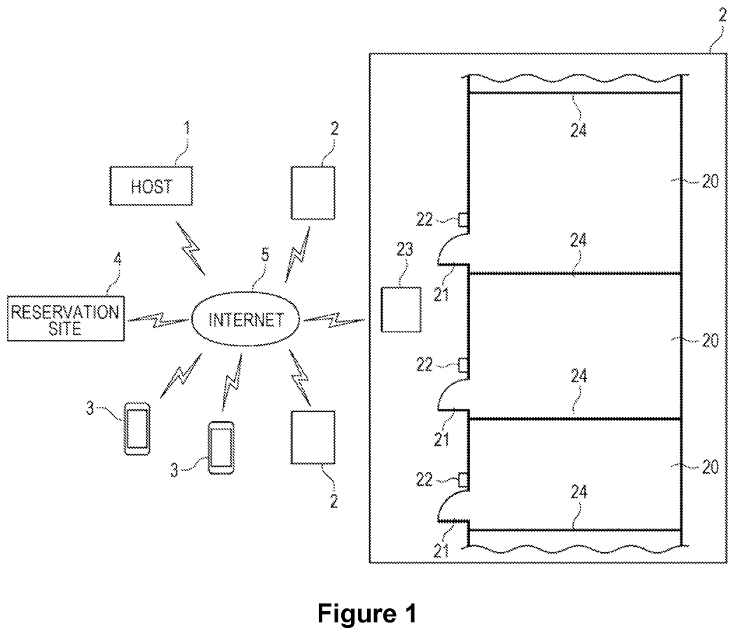

FIG. 1 is a schematic configuration diagram of an on-demand reservation system in accordance with some implementations.

As illustrated in FIG. 1, the on-demand reservation system includes a host 1 which is a management device for managing the facility, a plurality of rooms 20 as part of a facility for renting to users, and a plurality of buildings 2 having respective pluralities of rooms 20. The host 1, buildings 2, terminal devices 3 (e.g., mobile phones, smart phones, or personal computers owned by users), and a reservation site 4 for reserving rentals of the rooms 20 can be connected to each other via a public network 5 as a communication line (e.g., the Internet). Users can access the reservation site 4 via the Internet 5 using a terminal device 3 which is a user input unit, search for a room 20 according to a purpose, and specify a usage time to perform a reservation. When the reservation site 4 receives the reservation from the user, the reservation site 4 transmits reservation information including the room 20 for which the reservation has been confirmed and a reservation time to the host 1.

The building 2 includes rooms 20 such as a conference room and a training room, and each room 20 is provided with a doorway 21 and a locking device 22 for locking and unlocking the doorway 21. The locking device 22 can be unlocked by an authentication key such as a password or a bar code issued from the reservation site 4 to the terminal device 3 of the user, and the authentication key is randomly changed each time it is used, so that only the user who made a reservation at that time can unlock the locking device 22 by using a unique authentication key. A communication terminal device 23 such as a modem or a router is connected to each room 20 via a local area network (LAN), and the locking device 22 of each room 20 and accessory devices provided inside the room 20 are connected to the Internet 5 via the communication terminal device 23. In some implementations, the password, the bar code, or the like is used as an unlocking key, but for example, biometric authentication such as face authentication, fingerprint authentication, or retina authentication may be used, and any one can be used as long as the locking device 22 can be unlocked.

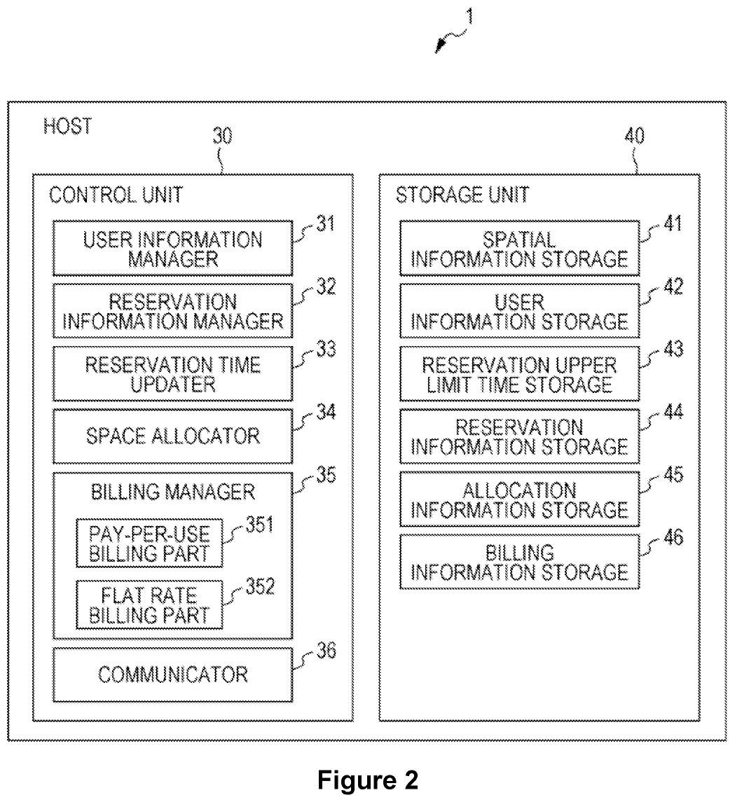

FIG. 2 is a block diagram illustrating a configuration of a management device of the on-demand reservation system in accordance with some implementations.

The host 1, which is the management device, includes a server device, including a control unit 30 including a central processing unit (CPU) and the like, and a storage unit 40 including a storage device such as a hard disk drive (HDD).

The control unit 30 includes a user information manager 31 that manages user information on a predetermined user registered in advance, and a reservation information manager 32 that manages the reservation information reserved by the user via the reservation site 4. The user information manager 31 manages a reservation upper limit time in which an upper limit time given to the registered user in advance and able to be reserved during a predetermined period is set. As used herein, “upper limit time” means an amount of time allotted for use by a user for one or more reservations. The amount of time allotted for the user (the upper limit time) may be spread across multiple reservations. When the amount of time allotted for the user is used up (expires), the upper limit time has been reached. When the reservation information manager 32 receives the usage time within a range not exceeding the reservation upper limit time from the terminal device 3, the reservation information manager 32 manages the usage time and reservation date and time as the reservation information. The control unit 30 includes a reservation time updater 33 that updates information of the reservation upper limit time by subtracting the usage time from the reservation upper limit time, when the reservation information manager 32 receives the reservation. The reservation time updater 33 updates the information of the reservation upper limit time by adding the usage time in the reservation information to the reservation upper limit time, when the reservation date and time of the reservation information has passed or when the reservation information has been deleted. Further, the control unit 30 includes a space allocator 34 that allocates the room 20 to be rented on the basis of the reservation information, a billing manager 35 that charges a rental fee of the room 20 to be rented, and a communicator 36 that controls communication with the communication terminal device 23, the reservation site 4, and the terminal device 3 of the user.

The billing manager 35 includes a pay-per-use billing part 351 that charges the rental fee of the room 20 to be rented according to each reservation from the user, and a flat rate billing part 352 that charges a flat rate rental fee according to a length of the reservation upper limit time during the predetermined period. The pay-per-use billing part 351 calculates and charges the rental fee according to usage date and time and the usage time of the room 20 received from the user via the reservation site 4, a size of the room 20, and the like. When the flat rate billing part 352 receives registration for flat rate usage from the user via the reservation site 4, it determines the predetermined period of, for example, one month from start of use, sets a predetermined reservation upper limit time during the predetermined period, and charges the flat rate rental fee on the basis of the reservation upper limit time.

The storage unit 40 includes a spatial information storage 41 that stores information of all the rooms 20 to be managed, a user information storage 42 that stores the user information of the predetermined user, a reservation upper limit time storage 43 that stores the reservation upper limit time in association with the user information of the predetermined user, a reservation information storage 44 that stores the reservation information including the usage time for using the room 20 and the reservation date and time, and an allocation information storage 45 that stores allocation information of the room 20 in association with the reservation information, and a billing information storage 46 that stores the rental fee of the room 20 in association with the reservation information. The control unit 30 causes the user information storage 42 to store the user information of the user registered by the user information manager 31, and causes the reservation upper limit time storage 43 to store the reservation upper limit time set in advance by the user. Further, when the reservation information manager 32 of the control unit 30 receives the reservation from the user, it causes the reservation information storage 44 to store the reservation information, and causes the space allocator 34 to allocate the room 20 to be rented, to cause the allocation information storage 45 to store the allocation information of the room 20. Further, when the billing manager 35 of the control unit 30 receives each reservation, the pay-per-use billing part 351 calculates and charges the rental fee, the flat rate billing part 352 charges the rental fee to the user of the flat rate usage according to the length of the reservation upper limit time during the predetermined period, and the pay-per-use billing part 351 and the flat rate billing part 352 cause the billing information storage 46 to store billing information.

Note that the user information manager 31, the reservation information manager 32, the reservation time updater 33, the space allocator 34, the billing manager 35, and the communicator 36 may be executed as a program by the CPU of the server device, may be configured by independent devices, or may be configured to use cloud computing. Further, the storage unit 40 may be configured by the storage device such as the HDD, or may use a storage unit of a cloud service. Furthermore, the terminal device 3 that functions as the user input unit may be a device such as a smartphone including an input part that receives input from the user, a display that notifies the user of information, a communicator for transmitting and receiving the information to and from the host 1, and a controller for controlling the input part, the display, the communicator, and the like, or may be a device in which the input part, the display, the communicator, and the controller are configured by the independent devices.

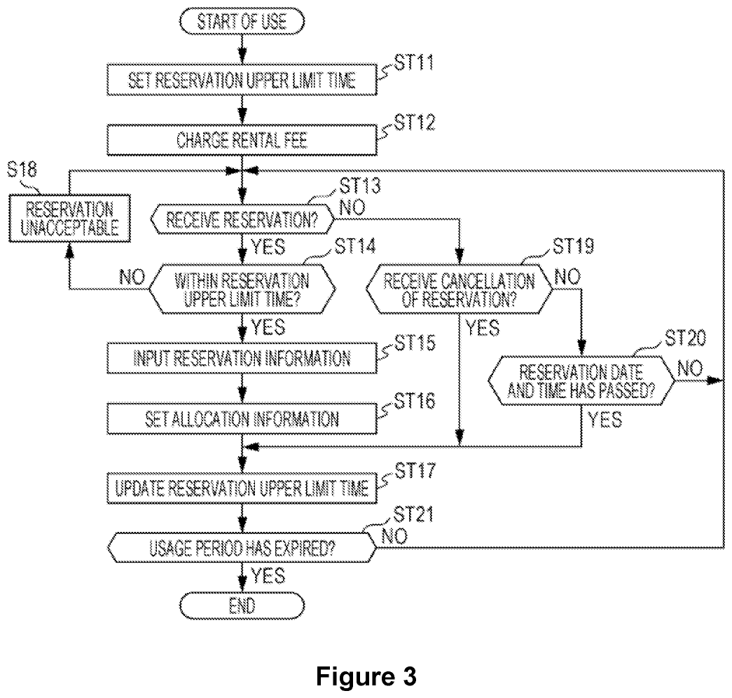

FIG. 3 is a flowchart illustrating an operation of the management device of the on-demand reservation system in accordance with some implementations.

The flowchart of FIG. 3 illustrates an operation procedure of the host 1 related to the reservation for using the facility for one month as the predetermined period, and the operation procedure of the host 1 related to the flat rate usage. The control unit 30 of the host 1 starts using the flat rate usage for the predetermined period (for example, one month) registered by the user, and causes the reservation upper limit time storage 43 to store the reservation upper limit time preset for the registered user in association with the user information stored in the user information storage 42 (reservation upper limit time setting step: Step ST11). The reservation upper limit time can be arbitrarily set (e.g., set to 5 hours or 10 hours). A case where the reservation upper limit time is set to 3 hours is described below. Subsequently, the flat rate billing part 352 of the control unit 30 charges the rental fee according to the reservation upper limit time (e.g., 3 hours) of the predetermined period, and the billing manager 35 causes the billing information storage 46 to store the billing information, and bills the registered user (rental fee billing step: Step ST12).

Subsequently, the control unit 30 enters a standby state of waiting for reception of the reservation from the reservation site 4. When the reservation information manager 32 receives the reservation from the reservation site 4 in the standby state (YES in Step ST13), it is determined whether the usage time is within the reservation upper limit time on the basis of the usage time included in the reservation information and the reservation upper limit time stored in the reservation upper limit time storage 43 (Step ST14). When the reserved usage time is within the reservation upper limit time (YES in Step ST14), the control unit 30 causes the reservation information storage 44 to store the reservation information, by the reservation information manager 32 (reservation information input step: Step ST15). Subsequently, the control unit 30 causes the space allocator 34 to set the allocation information of the room 20 to be rented on the basis of the reservation information and the information of all the rooms 20 stored in the spatial information storage 41, and causes the allocation information storage 45 to store the allocation information (allocation information setting step: Step ST16). Subsequently, the control unit 30 updates the information of the reservation upper limit time by subtracting the usage time from the reservation upper limit time by the reservation time updater 33 on the basis of the usage time included in the received reservation information, and causes the reservation upper limit time storage 43 to store the updated reservation upper limit time (reservation upper limit time update step: Step ST17).

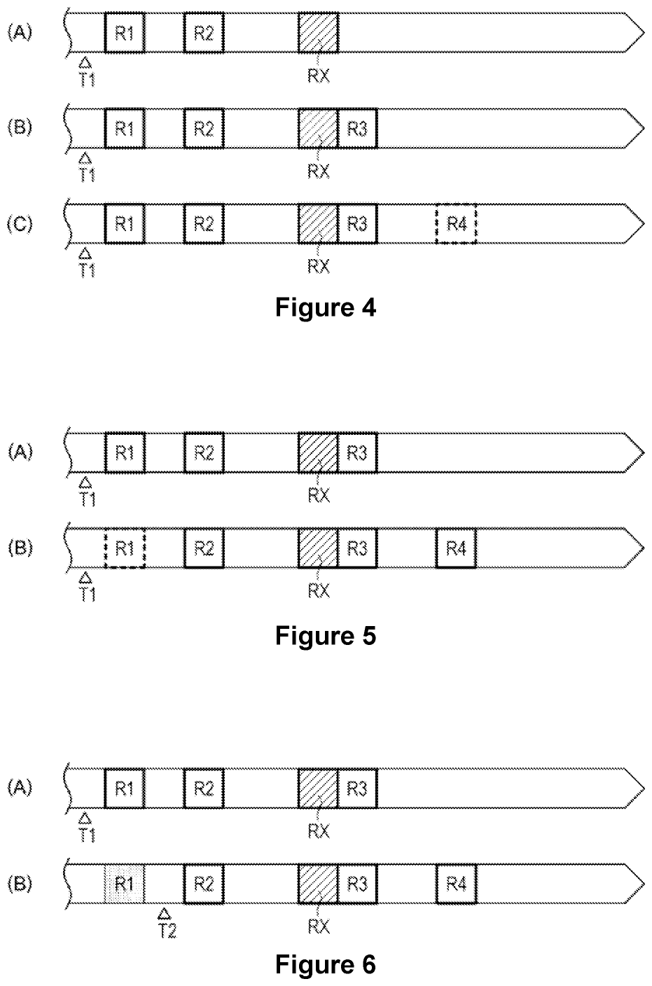

FIGS. 4(A) to 4(C) are diagrams illustrating a reservation operation in the on-demand reservation system.

As illustrated in FIG. 4(A), at a certain time point T1, first and second reservations R1 and R2 having a usage time of one hour have already been input for the registered user having the reservation upper limit time of three hours, and another reservation RX of another user has been input. At this time, the reservation upper limit time is one hour after subtracting two hours, which is a total of the first and second reservations R1 and R2, from initial three hours. Here, as illustrated in FIG. 4(B), when a new third reservation R3 with a usage time of one hour is received from the user (Step ST13), and the third reservation R3 does not overlap the other reservation RX, the reservation information manager 32 determines that the usage time (one hour) of the third reservation R3 is within the reservation upper limit time (one hour) (YES in Step ST14), and causes the reservation information storage 44 to store the third reservation R3 (Step ST15). Further, the reservation time updater 33 updates the information of the reservation upper limit time by subtracting the usage time of the third reservation R3 from the reservation upper limit time, and causes the reservation upper limit time storage 43 to store the updated reservation upper limit time (zero hours) (reservation upper limit time update step: Step ST17).

On the other hand, when it is determined in Step ST14 that the usage time exceeds the reservation upper limit time (NO in Step ST14), the reservation information manager 32 processes the reservation as unacceptable (Step ST18), and the control unit 30 returns to the standby state. That is, as illustrated in FIG. 4(C), when the first to third reservations R1, R2, and R3 have already been input and the reservation upper limit time is zero hours, even if a new fourth reservation R4 is received, the reservation information manager 32 determines that the usage time (one hour) of the fourth reservation R4 exceeds the reservation upper limit time (zero hours) (NO in Step ST14). Therefore, the new fourth reservation R4 is not input, the reservation upper limit time is not updated, and the control unit 30 is in the standby state.

Further, as illustrated in FIG. 3, when the control unit 30 does not receive a new reservation (NO in Step ST13) and receives cancellation of the reservation (YES in Step ST19) in the standby state, the reservation information manager 32 deletes the reservation information related to the reservation for which the cancellation has been received from the reservation information storage 44. Further, the control unit 30 updates the information of the reservation upper limit time by adding the usage time to the reservation upper limit time by the reservation time updater 33 on the basis of the usage time included in the reservation information, and causes the reservation upper limit time storage 43 to store the updated reservation upper limit time (reservation upper limit time update step: Step ST17). Further, when the control unit 30 does not receive the new reservation (NO in Step ST13) and does not receive the cancellation of the reservation (NO in Step ST19) in the standby state, and the reservation date and time of the nearest reservation has passed (YES in Step ST20), the reservation information manager 32 deletes the reservation information related to the reservation from the reservation information storage 44. Furthermore, the control unit 30 updates the information of the reservation upper limit time by adding the usage time to the reservation upper limit time by the reservation time updater 33 on the basis of the usage time included in the deleted reservation information, and causes the reservation upper limit time storage 43 to store the updated reservation upper limit time (reservation upper limit time update step: Step ST17). If the reservation date and time of the nearest reservation has not passed (NO in Step ST20), the control unit 30 returns to the standby state.

FIGS. 5(A) and 5(B) are diagrams illustrating another reservation operation in the on-demand reservation system.

FIG. 5(A) illustrates, as in FIG. 4(B), at the certain time point T1, a state in which the first to third reservations R1, R2, and R3 having a usage time of one hour for the user having the reservation upper limit time of three hours have already been input, and the reservation upper limit time is zero hours. From this state, as illustrated in FIG. 5(B), when the first reservation R1 is canceled (YES in Step ST19), the reservation information manager 32 deletes the first reservation R1 from the reservation information storage 44, and the reservation time updater 33 updates the information of the reservation upper limit time by adding the usage time of the first reservation R1 to the reservation upper limit time, and causes the reservation upper limit time storage 43 to store the updated reservation upper limit time (one hour) (Step ST17). Therefore, it is possible to accept a new fourth reservation R4 within a range in which the usage time does not exceed one hour.

FIGS. 6(A) and 6(B) are diagrams illustrating still another reservation operation in the on-demand reservation system.

FIG. 6(A) illustrates, as in FIG. 4(B), at the certain time point T1, the state in which the first to third reservations R1, R2, and R3 having the usage time of one hour for the user having the reservation upper limit time of three hours have already been input, and the reservation upper limit time is zero hours. From this state, as illustrated in FIG. 6(B), when a time point T2 is reached when the reservation date and time of the first reservation R1 has passed (YES in Step ST20), the reservation information manager 32 deletes the first reservation R1 from the reservation information storage 44, and the reservation time updater 33 updates the information of the reservation upper limit time by adding the usage time of the first reservation R1 to the reservation upper limit time, and causes the reservation upper limit time storage 43 to store the updated reservation upper limit time (one hour) (Step ST17). Therefore, it is possible to accept the new fourth reservation R4 within the range in which the usage time does not exceed one hour.

As described above, the control unit 30 updates the reservation upper limit time by the reservation time updater 33 on the basis of the reception of the reservation, the cancellation of the reservation, or lapse of the reservation date and time, so that the user can repeatedly input a new reservation. Then, the control unit 30 repeats the above steps (Steps ST13 to ST20) until a time when the predetermined period of the flat rate usage ends (for example, a day when one month elapses from the start of use), and when it is determined that the predetermined period has passed and a usage period has expired (YES in Step ST21), the control unit 30 ends the process.

According to the implementations described herein, the following operations and effects can be obtained.

(1) The host 1 of the on-demand reservation system includes the user information manager 31 that manages the user information and the reservation upper limit time, the reservation information manager 32 that manages the usage time and the reservation date and time as the reservation information, and the reservation time updater 33 that updates the information of the reservation upper limit time by subtracting the usage time from the reservation upper limit time, and the reservation time updater 33 updates the information of the reservation upper limit time by adding the usage time in the reservation information to the reservation upper limit time, when the reservation date and time of the reservation information has passed or when the reservation information has been deleted, so that the user can repeatedly reserve and use the room 20 during the predetermined period. Therefore, the user can easily make a reservation as long as the reservation upper limit time is not exceeded, and convenience of the user can be improved. Further, when the reservation date and time has passed or when the reservation information has been deleted (cancelled), the usage time for the reservation is added to update the reservation upper limit time, so that the user is encouraged to actively make a reservation, and operation efficiency of the room 20 can be improved.

(2) The host 1 includes the flat rate billing part 352 of the billing manager 35 that charges the rental fee according to the length of the reservation upper limit time during the predetermined period, so that the user can repeatedly use the room 20 of the on-demand reservation system at the flat rate within the range not exceeding the reservation upper limit time.

### Additional Implementations

Note that the present disclosure is not limited to the above implementations, and modifications, improvements, and the like within the range in which the object of the present disclosure can be achieved are included in the present disclosure.

For example, in the above implementations, a rental room in which the room 20 of building 2 is rented is exemplified as the on-demand reservation system, but the on-demand reservation system is not limited to the rental room such as a conference room, and may be a rental space such as a tennis court, a baseball field, a stadium, or a parking lot, which are outdoor spaces, or a karaoke room, a rental office, a reading space, or the like. Further, the facility to be rented is not limited to a facility attached to real estate such as a building 2, and may be movable property such as various goods.

Further, in the above implementations, the on-demand reservation system groups the rooms 20 of the buildings 2, and the user can repeatedly use the room 20 of the on-demand reservation system at the flat rate within the range not exceeding the reservation upper limit time, but the number of buildings 2 may be one, and the number of rooms 20 may be one.

In the above implementations, a case where the host 1 as the management device includes the server device connected to the building 2 and to the reservation site 4, via the Internet 5 which is the communication line is exemplified, but the management device is not limited to that including such a centralized management type server device. That is, the management device may be a distributed management type device, for example, a device using a distributed transaction ledger typified by blockchain can be used, and any device that can manage the user information and the reservation information can be used. Further, in the above implementations, the host 1 as the management device and the reservation site 4 are separately provided and connected to each other via the Internet 5, but the present disclosure is not limited to this, and the host 1 and the reservation site 4 may be provided in a single site, or the function of the management device and the function of the reservation site may be implemented by a plurality of devices distributed on the Internet.

In the above implementations, the control unit 30 sets the reservation upper limit time in units of one month as the predetermined period, and charges the rental fee on the basis of the reservation upper limit time, but the predetermined period is not limited to one month, but may be one week, six months, one year, or an indefinite period, and a length of the predetermined period can be appropriately set. Further, in the above implementations, the reservation upper limit time cannot be changed during the predetermined period, but the present disclosure is not limited to this, and the reservation upper limit time may be changed during the predetermined period. In that case, the billing manager is only required to have a function of calculating the rental fee by an appropriate billing method such as daily proration.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

What is claimed is:

1. An on-demand reservation system, comprising:
a management server connected to a terminal device via a communication network and including one or more processors and memory storing one or more programs to be executed by the one or more processors, the one or more programs including instructions for:
obtaining user information of a user from the terminal device;
setting a reservation upper limit time for the user to make reservations during a predetermined period;
receiving a first reservation having a first usage time from the terminal device;
determining whether the first usage time exceeds the reservation upper limit time; and
in accordance with a determination that the first usage time does not exceed the reservation upper limit time:
managing a reservation date and time as reservation information of the first reservation; and
generating a first updated reservation upper limit time by subtracting the first usage time from the reservation upper limit time.

2. The on-demand reservation system of claim 1, wherein the one or more programs further include instructions for:
determining whether the reservation date and time of the reservation information has lapsed; and
in accordance with a determination that the reservation date and time of the reservation information has lapsed, generating a second updated reservation upper limit time by adding the first usage time to the first updated reservation upper limit time.

3. The on-demand reservation system of claim 1, wherein the one or more programs further include instructions for:
determining whether the reservation information has been deleted; and
in accordance with a determination that the reservation information has been deleted, generating a second updated reservation upper limit time by adding the first usage time to the first updated reservation upper limit time.

4. The on-demand reservation system of claim 1, wherein the one or more programs further include instructions for:
receiving a second reservation having a second usage time from the terminal device;
determining whether the second usage time exceeds the first updated reservation upper limit time; and
in accordance with a determination that the second usage time exceeds the first updated reservation upper limit time, processing the second reservation as unacceptable.

5. The on-demand reservation system of claim 4, wherein the one or more programs further include instructions for:
receiving a third reservation having a third usage time from the terminal device;
determining whether the third usage time exceeds the second updated reservation upper limit time; and
in accordance with a determination that the third usage time does not exceed the second updated reservation upper limit time:
managing a reservation date and time as reservation information of the third reservation; and
generating a third updated reservation upper limit time by subtracting the third usage time from the second updated reservation upper limit time.

6. The on-demand reservation system of claim 1, wherein the one or more programs further include instructions for:
charging a rental fee according to a length of the reservation upper limit time during the predetermined period.

7. The on-demand reservation system of claim 6, wherein:
the rental fee is a flat rate having a first amount; and
the one or more programs further include instructions for maintaining the first amount of the rental fee subsequent to generating the first updated reservation upper limit time.

8. The on-demand reservation system of claim 1, wherein the one or more programs further include instructions for:
determining whether the reservation date and time of the first reservation exceed the predetermined period;
wherein managing the reservation date and time and generating the first updated reservation upper limit time are further in accordance with a determination that the reservation date and time do not exceed the predetermined period.

9. The on-demand reservation system of claim 1, wherein:
the reservation upper limit time is an amount of time allotted for use by the user for one or more reservations; and
the predetermined period is a deadline by which the amount of time allotted for us by the user must be used.

10. The on-demand reservation system of claim 1, wherein:
the reservation upper limit is an amount of time between three hours and ten hours; and
the predetermined period is greater than or equal to one week after receiving the first reservation.

11. A method of operating an on-demand reservation system, the method comprising:
at a management server connected to a terminal device via a communication network and including one or more processors and memory:
obtaining user information of a user from the terminal device;
setting a reservation upper limit time for the user to make reservations during a predetermined period;
receiving a first reservation having a first usage time from the terminal device;
determining whether the first usage time exceeds the reservation upper limit time; and
in accordance with a determination that the first usage time does not exceed the reservation upper limit time:
managing a reservation date and time as reservation information of the first reservation; and
generating a first updated reservation upper limit time by subtracting the first usage time from the reservation upper limit time.

12. The method of claim 11, further comprising, at the management server:
determining whether the reservation date and time of the reservation information has lapsed; and
in accordance with a determination that the reservation date and time of the reservation information has lapsed, generating a second updated reservation upper limit time by adding the first usage time to the first updated reservation upper limit time.

13. The method of claim 11, further comprising, at the management server:
determining whether the reservation information has been deleted; and
in accordance with a determination that the reservation information has been deleted, generating a second updated reservation upper limit time by adding the first usage time to the first updated reservation upper limit time.

14. The method of claim 11, further comprising, at the management server:
receiving a second reservation having a second usage time from the terminal device;
determining whether the second usage time exceeds the first updated reservation upper limit time; and
in accordance with a determination that the second usage time exceeds the first updated reservation upper limit time, processing the second reservation as unacceptable.

15. The method of claim 14, further comprising, at the management server:
receiving a third reservation having a third usage time from the terminal device;
determining whether the third usage time exceeds the second updated reservation upper limit time; and
in accordance with a determination that the third usage time does not exceed the second updated reservation upper limit time:
managing a reservation date and time as reservation information of the third reservation; and
generating a third updated reservation upper limit time by subtracting the third usage time from the second updated reservation upper limit time.

16. The method of claim 11, further comprising, at the management server:
charging a rental fee according to a length of the reservation upper limit time during the predetermined period.

17. The method of claim 16, wherein:
the rental fee is a flat rate having a first amount; and
the method further comprises, at the management server, maintaining the first amount of the rental fee subsequent to generating the first updated reservation upper limit time.

18. The method of claim 11, further comprising, at the management server:
determining whether the reservation date and time of the first reservation exceed the predetermined period;
wherein managing the reservation date and time and generating the first updated reservation upper limit time are further in accordance with a determination that the reservation date and time do not exceed the predetermined period.

19. The method of claim 11, wherein:
the reservation upper limit time is an amount of time allotted for use by the user for one or more reservations; and
the predetermined period is a deadline by which the amount of time allotted for us by the user must be used.

20. The method of claim 11, wherein:
the reservation upper limit is an amount of time between three hours and ten hours; and
the predetermined period is greater than or equal to one week after receiving the first reservation.
